(19) United States
(12) Patent Application Publication
(10) Pub. No.: US 2023/0010929 A1
(43) Pub. Date: Jan. 12, 2023

(54) DIGITAL VOUCHER MARKETPLACE

(71) Applicant: Ahmed Khogheer, Springfield Gardens, NY (US)

(72) Inventor: Ahmed Khogheer, Springfield Gardens, NY (US)

(21) Appl. No.: 17/367,984

(22) Filed: Jul. 6, 2021

(51) Int. Cl. G06Q 30/02; G06Q 20/12; G06Q 40/02; G06Q 20/38; G06Q 20/08; G06Q 10/10; G06Q 20/40; G06F 16/9535

(52) U.S. Cl. CPC G06Q 30/0222; G06Q 20/123; G06Q 40/02; G06Q 20/387; G06Q 20/085; G06Q 30/0206; G06Q 10/10; G06Q 20/4037; G06Q 30/0235; G06F 16/9535

(57) ABSTRACT

A voucher marketplace system comprising a control server, a platform database, and a plurality of user devices operated by users corresponding to buyer accounts and seller accounts. The voucher marketplace system allows digital vouchers to be created by the seller accounts and purchased by the buyer accounts at a virtual price. Each digital voucher can redeemed by the owning buyer account to trigger execution of a commercial transaction via an e-commerce platform, or be sold to another buyer account. Each digital voucher may have claim parameters which modify the virtual price and define effective execution periods during which the digital voucher is redeemable, whereby the virtual price is reduced by a lead period discount when sold prior to the effective execution period, The voucher marketplace system further presents pricing data reports which compare the virtual price of the digital vouchers against a market price corresponding to completed voucher sale transactions.

### TECHNICAL FIELD

The present disclosure relates generally to an electronic platform for purchasing goods or services. More particularly, the present disclosure relates to a digital marketplace for buying and selling digital vouchers which are redeemable for goods or services.

### BACKGROUND

Trading products on digital marketplaces can carry significant risk for both suppliers of the products, and buyers who purchase the products to consume or to resell. The high complexity of trade ecosystems makes it difficult for market participants to obtain timely and accurate information necessary to make informed decisions prior to making sales of purchases. Sellers can incur significant losses by either overpricing or underpricing their products or services. Overpricing results in an inability to sell accumulated inventory, while underpricing leads to lost revenue and a potential devaluing of market value.

These problems can be addressed by electronically selling and trading vouchers which can be redeemed for an actual product or service. A digital marketplace which allows products or services to be sold in the form of vouchers offers several key advantages. A seller can reduce the need to accumulate inventory prior to generating sales by selling vouchers in advance of delivery of an actual product or service, allowing the vouchers to be redeemed for the actual product or service at a later date. Buyers can be encouraged to purchase the vouchers in advance of delivery by offering discounts prior to the vouchers becoming redeemable. Buyers seeking to purchase products for resale at a higher price are not required to process actual inventory, while consumers wishing to purchase products or services for actual consumption may purchase vouchers for redemption. Furthermore, a digital marketplace which gathers, analyzes, and delivers accurate information regarding historical market trends and future impacts, can reduce risks and inefficiencies caused by overpricing and underpricing.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is to provide a digital marketplace which allows products and services to be purchased through transferable vouchers. Accordingly, the present disclosure provides a voucher marketplace system having a plurality of users categorized as seller accounts or buyer accounts. The voucher marketplace system allows digital vouchers to be created by seller accounts for purchase by buyer accounts. Each digital voucher has an issuer corresponding to the seller account, and an owner corresponding to the purchasing buyer account. Each digital voucher is associated with redemption action data which describes a commercial transaction such as provision of a product or service, and the issuer of the digital voucher may be a merchant responsible for fulfilling the commercial transaction. The owner of the digital voucher is entitled to redeem the digital voucher, causing the commercial transaction described within the redemption action data to be carried out. Each digital voucher has a virtual price, and can be defined independently of the general market value of the product or service associated with the digital voucher, thus allowing the digital voucher to be sold at a virtual price which is higher or lower than the general market value. Furthermore, the voucher marketplace system allows the owner of a digital voucher to sell the digital voucher to another buyer user prior to redeeming the digital voucher.

It is another aspect of an example embodiment in the present disclosure to provide information to the users of the voucher marketplace system to prevent market inefficiencies. Accordingly, the voucher marketplace system is adapted to record and analyze historical pricing data gathered from completed voucher sale transactions, and prepare buyer oriented buyer pricing data reports and seller oriented seller pricing data reports to allow the buyers and sellers to make informed decisions to reduce market inefficiencies. Furthermore, the buyer and seller pricing data reports also display a market price corresponding to the sale price of the most recent completed voucher sale, thus allowing the virtual price of each digital voucher to be compared to the market price.

It is yet another aspect of an example embodiment in the present disclosure, to allow the virtual price of the digital vouchers to be adjusted using time-based conditions on pricing and redemption. Accordingly, each digital voucher may have an effective execution period during which the digital voucher is allowed to be redeemed by its owner. The virtual price of the digital voucher may be increased by an effective execution period premium which is calculated in proportion to the duration of the effective execution period. The digital voucher may also have a lead period which precedes the effective execution period, during which redemption of the digital voucher is not permitted. However, virtual price of the digital voucher may be reduced by a lead period discount when the digital voucher is purchased during the lead period.

It is a further aspect of an example embodiment in the present disclosure to allow the digital vouchers to be associated with a quantity of digital credit for use in funding transactions, in lieu of the provision of a product or service. Accordingly, the redemption action data of a digital voucher may define a digital credit balance, whereupon execution of the redemption action causes the digital credit balance to be deducted to fund a credit-based transaction.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1A is a block diagram depicting a digital voucher marketplace system comprising a control server, a platform database, and a plurality of user devices, in accordance with an embodiment in the present disclosure.

FIG. 1B is a block diagram depicting an example architecture of the control server, in accordance with an embodiment in the present disclosure.

FIG. 1C is a block diagram depicting the digital voucher marketplace system implemented using a blockchain transaction network, in accordance with an embodiment in the present disclosure.

FIG. 1D is a block diagram depicting use devices communicating with the control server via a platform application and a platform website, in accordance with an embodiment in the present disclosure.

FIG. 1E is a block diagram depicting a buyer account profile and a seller account profile, in accordance with an embodiment in the present disclosure.

FIG. 2A is a block diagram depicting the digital voucher marketplace system carrying out voucher sale transactions, in accordance with an embodiment in the present disclosure.

FIG. 2B is a block diagram depicting an example voucher record, in accordance with an embodiment in the present disclosure.

FIG. 2C is a block diagram depicting a redemption action data example containing an item description and delivery data, in accordance with an embodiment in the present disclosure.

FIG. 2D is a block diagram depicting a redemption action data example which defines a digital credit balance, in accordance with an embodiment in the present disclosure.

FIG. 2E is a block diagram depicting an example voucher creation interface, in accordance with an embodiment in the present disclosure.

FIG. 2F is a block diagram depicting a primary voucher sale transaction, in accordance with an embodiment in the present disclosure.

FIG. 3 is a block diagram depicting an example voucher redemption , in accordance with an embodiment in the present disclosure.

FIG. 4A is a block diagram depicting claim parameters of a digital voucher, in accordance with an embodiment in the present disclosure.

FIG. 4B is a block diagram depicting an example of variable pricing for a digital voucher having fixed claim parameters, in accordance with an embodiment in the present disclosure.

FIG. 4C is a block diagram depicting a lead period, an effective execution period, and a post execution period for a digital voucher with variable claim parameters, in accordance with an embodiment in the present disclosure.

FIG. 4D is a flowchart depicting an example voucher pricing process, in accordance with an embodiment in the present disclosure.

FIG. 5A is a block diagram depicting classification data used to categories digital vouchers, in accordance with an embodiment in the present disclosure.

FIG. 5B is a block diagram depicting an example buyer interface, in accordance with an embodiment in the present disclosure.

FIG. 6 is a block diagram depicting the voucher execution carrying out expiration actions, in accordance with an embodiment in the present disclosure.

FIG. 7 is a block diagram depicting a secondary voucher sale transaction, in accordance with an embodiment in the present disclosure.

FIG. 8 is a block diagram depicting the market transaction module executing automated rules for purchasing or selling digital vouchers based on stock market order types, in accordance with an embodiment in the present disclosure.

FIG. 9 is a block diagram depicting a primary voucher sale transaction being carried out using a negotiated price, in accordance with an embodiment in the present disclosure.

FIG. 10 is a block diagram depicting payment transactions being carried out via the payment module, in accordance with an embodiment in the present disclosure.

FIG. 11 is a block diagram depicting the pricing analysis module generating buyer and seller pricing data reports based on historical pricing data, in accordance with an embodiment in the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

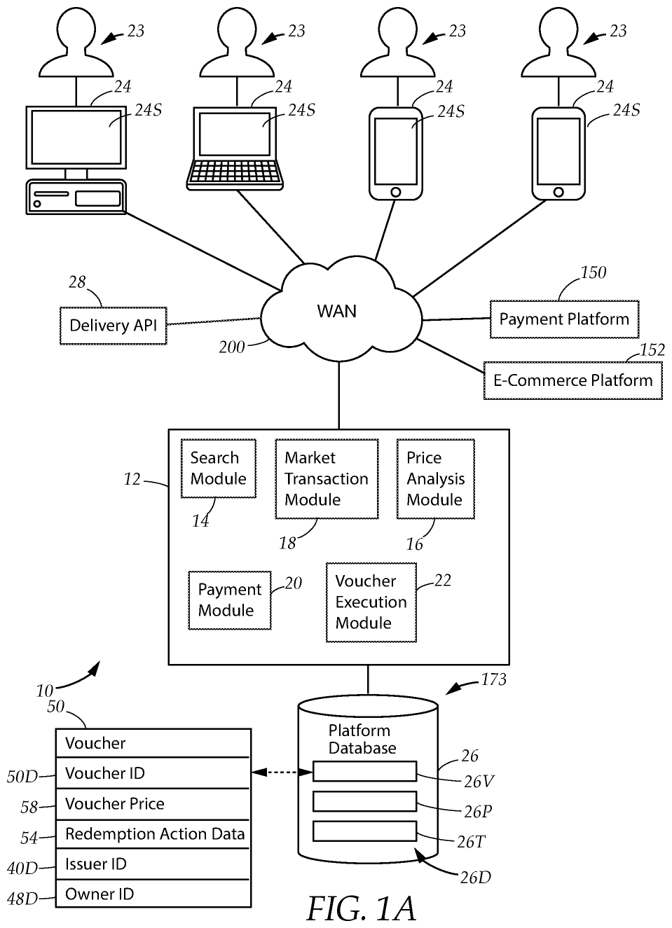

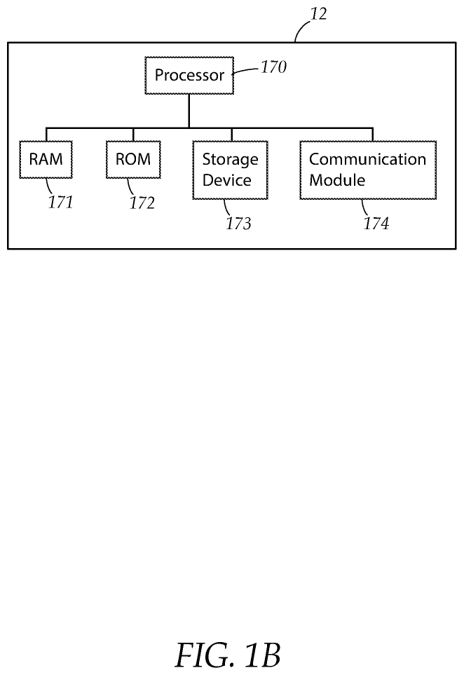

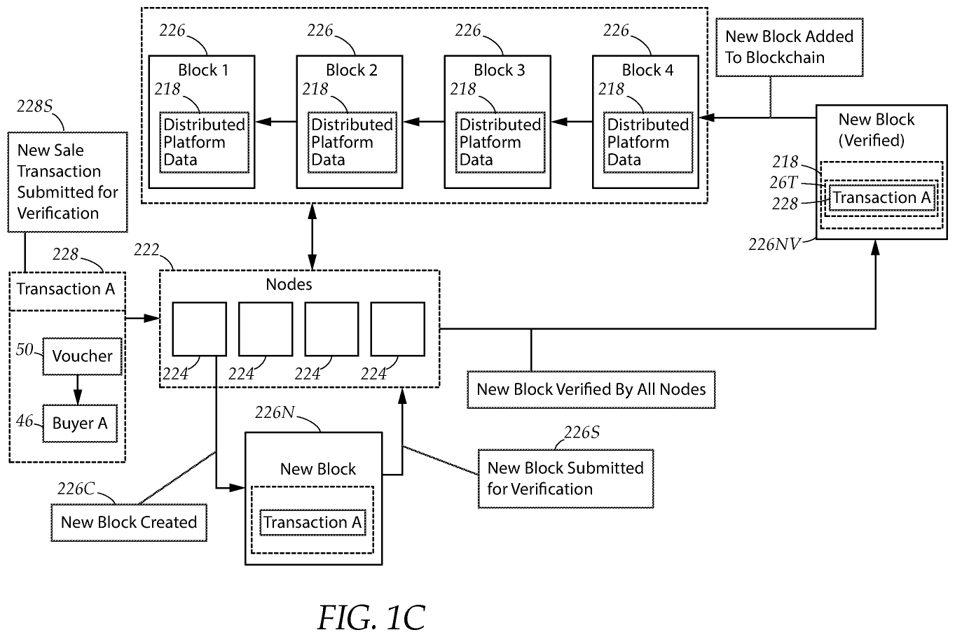

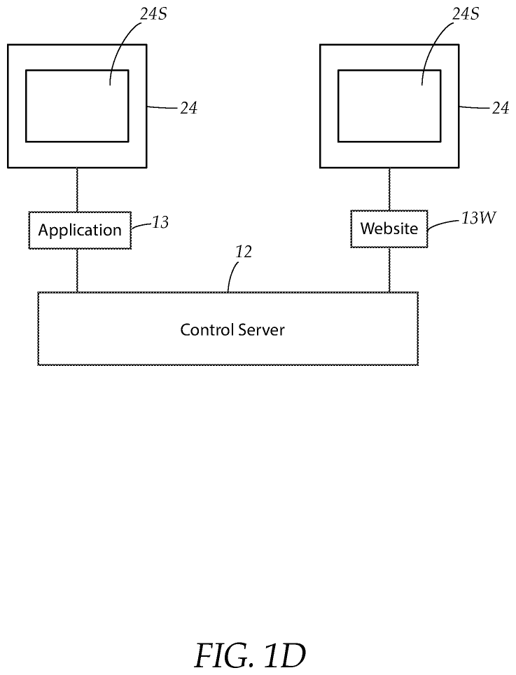

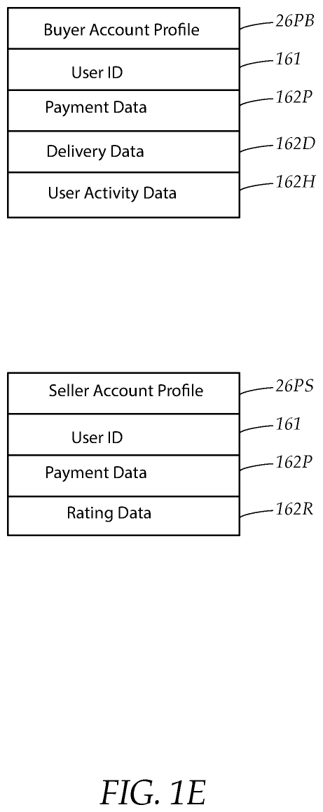

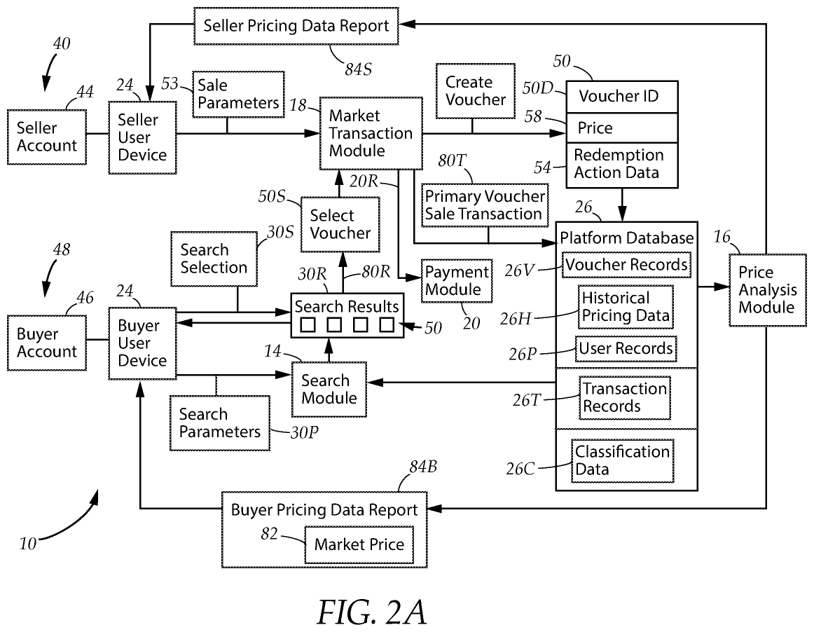

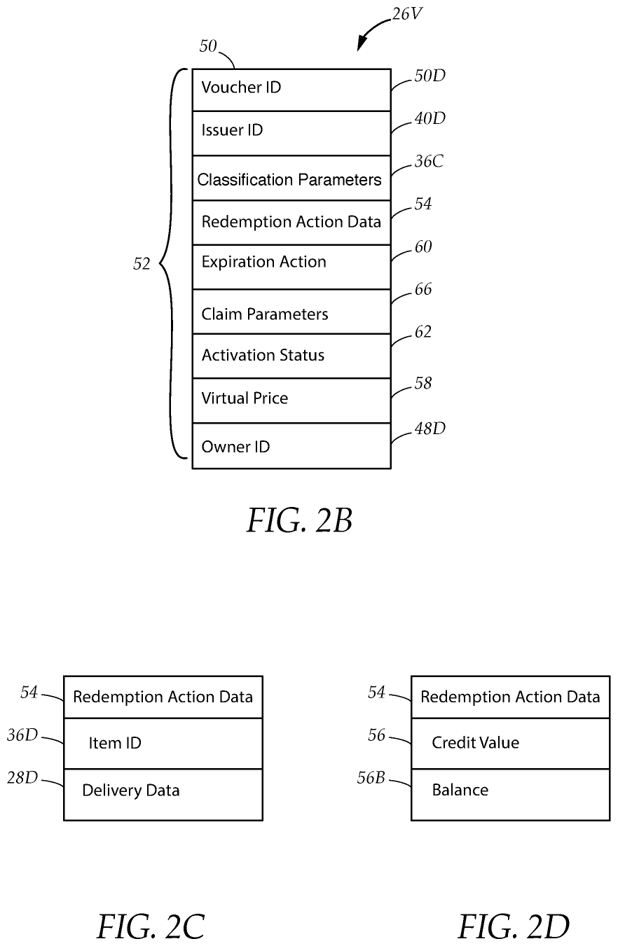

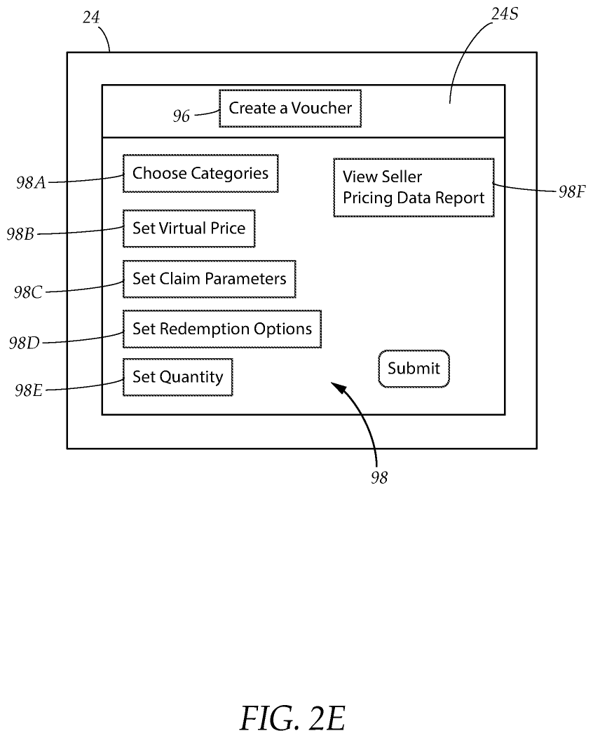

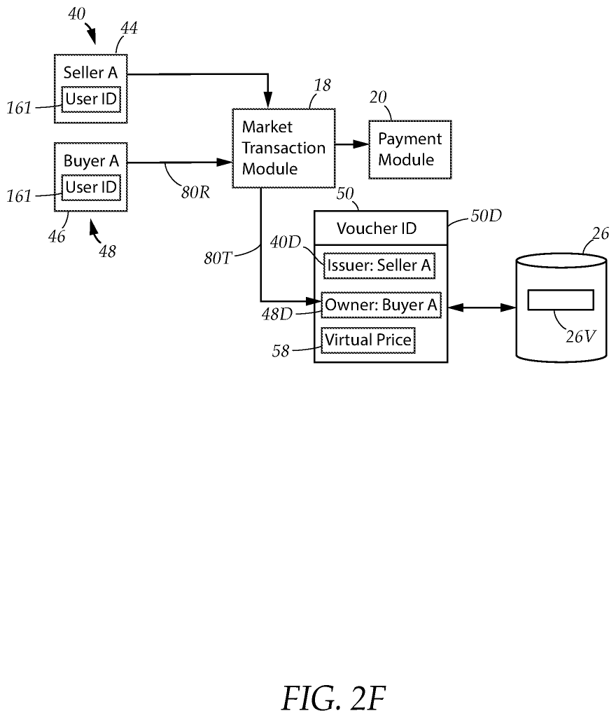

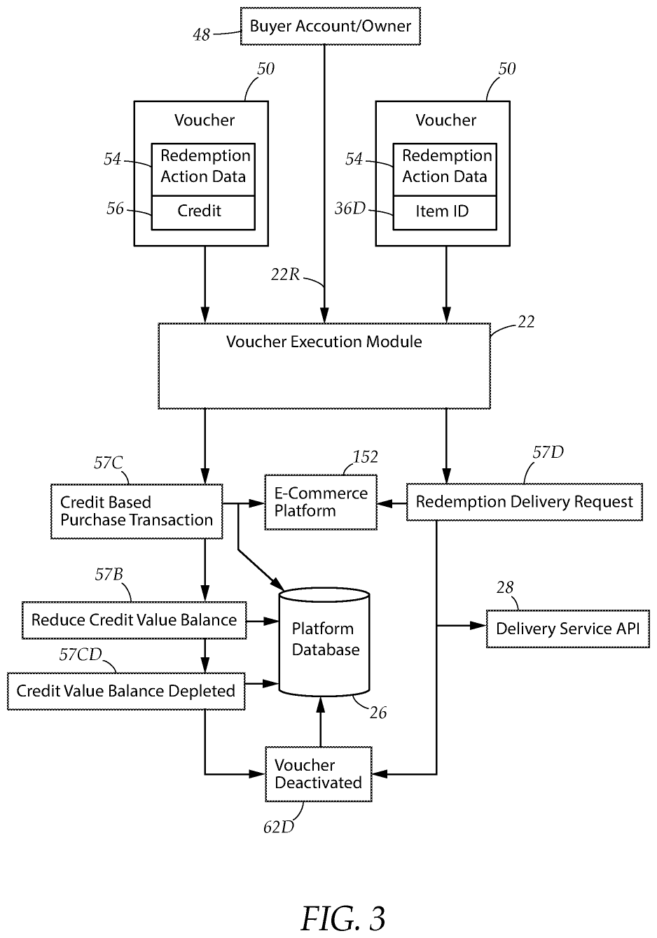

FIG. 1A, FIGS. 2A-B, and FIG. 3 illustrate a voucher marketplace system 10 for conducting digital transactions using digital vouchers 50. Each digital voucher 50 has a virtual price 58, and is associated with a redemption action. The redemption action is a commercial transaction involving the transfer of a product or performance of a service. Each digital voucher 50 has an issuer 40 corresponding to an entity responsible for fulfilling the redemption action, and an owner 48 entitled to trigger the redemption action by redeeming the digital voucher 50.

The voucher marketplace system 10 has a plurality of user types 23 comprising seller accounts 44 and buyer accounts 46. The voucher marketplace system 10 allows digital vouchers 50 to be created at the request of seller accounts 44 and purchased by one of the buyer accounts 46. The seller account 44 initiating the creation of a digital voucher 50 is associated with the digital voucher 50 as the issuer 40. The voucher marketplace system 10 allows a buyer account 46 to purchase a digital voucher 50 held by the issuer 40 through a primary voucher sale transaction 80T. The purchasing buyer account 46 is then associated with the digital voucher 50 as the owner 48.

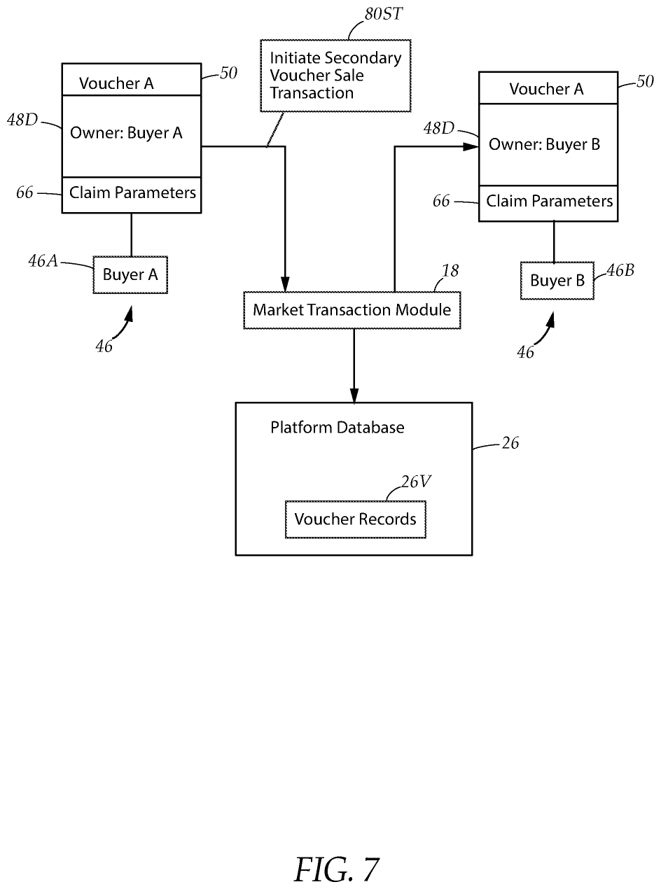

Each digital voucher 50 has a plurality of voucher data elements 52, including the virtual price 58, and redemption action data 54 which allows the redemption action to be executed through the voucher marketplace system 10. In one embodiment, the redemption action may cause the voucher marketplace system 10 to transmit a command to an e-commerce platform 152 to deliver a product or initiate performance of a service, or debit a digital credit balance for purchasing products or services. Referring briefly to FIG. 7, instead of redeeming the digital voucher 50, the owner 48 may sell the digital voucher 50 to another buyer account 46 via a secondary voucher sale transaction 80ST, whereupon said buyer account 46 is associated with the digital voucher 50 as the new owner 48.

Referring to FIG. 1A and FIG. 1B, in a preferred embodiment, the voucher marketplace system 10 comprises a control server 12, a platform database 26, and a plurality of user devices 24. The control server 12 is a computing device adapted to execute the computer program code of the various modules, as well as communicate with the user devices 24 via a data communication network 200 such as the internet or other wide area network. In one embodiment, the control server 12 has a processor 170, a RAM 171, a ROM 172, a computer storage device 173, and a communication module 174 adapted to communicate electronically via the data communication network 200 with the user devices 24 and other computing devices using a communications protocol. In certain embodiments, the functions of the control server 12 may be distributed across multiple computing devices.

The control server 12 has a plurality of modules adapted to carry out a plurality of marketplace functions, and may be implemented using software components, packages, assemblies, as will be apparent to a person of ordinary skill in the art in the field of the invention. In one embodiment, the modules comprise a market transaction module 18, a search module 14, a payment module 20, a pricing analysis module 16, and a voucher execution module 22.

Referring to FIG. 1A, FIG. 2A, and FIG. 7, the search module 14 allows the buyer accounts 46 to search through the voucher records 26V stored within the platform database 26 using a range of search parameters 30P in order to identify digital vouchers 50 for purchase. The market transaction module 18 is adapted to create new digital vouchers 50 as well as carry out primary and secondary voucher sale transactions 80T, 80ST. A primary voucher sale transaction 80T is carried out between a seller account 44 issuing a digital voucher 50, and a buyer account 46 which purchases the digital voucher 50 and becomes the owner 48. A secondary voucher sale transaction 80ST is carried out between two buyer accounts 46, whereby one of the buyer accounts 46 is the owner 48 of the digital voucher 50, and the buyer account 46 purchasing the digital voucher 50 becomes the new owner 48 thereof.

In one embodiment, the payment module 20 is adapted to carry out payment requests 20R, whereby payment is transferred to the issuer 40 as part of a primary voucher sale transaction 80T, or to the owner 48 as part of a secondary voucher sale transaction 80ST. The pricing analysis module 16 is adapted to gather historical pricing data 26H based on completed primary and secondary voucher sale transactions 80T, 80ST to generate buyer pricing data reports 84B and seller pricing data reports 84S to address inefficiencies caused by underpricing or overpricing of digital vouchers 50. Referring briefly to FIG. 3 while also referring to FIG. 2A, the voucher execution module 22 is adapted to allow the owner 48 of a digital voucher 50 to redeem the digital voucher 50, and cause the e-commerce platform 152 to carry out the redemption action.

Referring to FIG. 1A, FIG. 1D, and FIG. 2A, the user devices 24 provide user access to the voucher marketplace system 10, and allow users to input marketplace user commands for execution by the control server 12. The user devices 24 may be personal computers, smartphones, tablets, portable computing devices, or other appropriate computing devices which are adapted to communicate with the control server 12 via a data communication network 200 such as the internet, or other wide area network. Each user device 24 further has a device display 24S for displaying graphics and text as well as graphical user interface elements, and an input device for receiving user input, such as mouse, keyboard, touchscreen, or other suitable device.

In one embodiment, the user devices 24 and the control server 12 operate in a client-server relationship, whereby marketplace user commands are transmitted to the control server 12 by the user devices 24. The control server 12 is adapted to execute the requested functions, and transmit data responses to the requesting user devices 24.

Referring to FIG. 1D while also referring to FIG. 1A, the voucher marketplace system 10 may further comprise a platform application 13 implemented locally via the user devices 24, or a platform website 13W which is accessible by the user devices 24. The platform application 13 and the platform website 13W may present marketplace user commands via the device screen 24S of the user device 24, allowing the users to select desired marketplace user commands for transmission to the control server 12.

The platform database 26 contains a plurality of platform data elements 26D utilized by the modules of the control server 12 to carry out the marketplace functions. The platform data elements 26D may be stored within individual files, or as records. The platform data elements 26D may comprise a plurality of voucher records 26V, a plurality of user profiles 26P, and a plurality of transaction records 26T. In one embodiment, the files which form the platform database 26 are stored within the computer storage device 173 and are managed via the control server 12. In certain embodiments, the files of the platform database 26 may be stored on a separate file server or database server which is accessible to the control server 12.

Referring to FIG. 1E while also referring to FIG. 2A, the user profiles 26P may comprise individual database records for each user account, with each buyer account 46 being associated with a buyer account profile 26PB, and each seller account 44 being associated with a seller account profile 26PS. Each user profile 26P contains a plurality of user data elements, including a user identifier 161 which uniquely identifies each user account, as well as other appropriate data elements as necessary for executing transactions via the voucher marketplace system 10. In one embodiment, the data elements of each user profile 26P further contain payment data 162P, which is used by the payment module 20 to carry out payment transfers. Each buyer account profile 26PB may also contain user delivery data 162D, which may correspond to a delivery address.

Referring to FIGS. 2A-B and FIG. 2E while also referring to FIG. 1A and FIGS. 1D-E, each digital voucher 50 is embodied within the platform database 26 as a voucher record 26V which contains the voucher data elements 52 which determine the pricing and redemption characteristics of the digital voucher 50. The virtual price 58 may be defined by the seller account 44 at the time the digital voucher 50 is created. In addition to the virtual price 58 and the redemption action data 54, the voucher data elements 52 may further comprise a voucher identifier 50D, an issuer identifier 40D, and an owner identifier 48D. The voucher identifier 50D may be a unique alphanumeric sequence which is used to reference the digital voucher 50. For example, the market transaction module 12 may reference the voucher identifier 50D in order to retrieve or edit the appropriate voucher record 26V from the platform database 26. The issuer identifier 40D and the owner identifier 48D may correspond to the user identifiers 161 of the issuer 40 and the owner 48 of the digital voucher 50. The issuer identifier 40D is defined upon the creation of the digital voucher 50, while owner identifier 48D may remain undefined until the primary voucher sale transaction 80T is completed. The voucher data elements 52 may also contain an activation status 62. For example, the activation status 62 may correspond to an active status, a deactivated status, or other condition as appropriate. In one embodiment, a digital voucher 50 with the active activation status 62 may be sold and redeemed where appropriate. However, a digital voucher 50 with the deactivated activation status 62 may not be sold or redeemed.

A voucher creation request may be initiated by a seller account 44 through one of the user devices 24 in order to create a new digital voucher 50. The request contains a plurality of sale parameters 53, which are used to define the voucher data elements 52. In one embodiment, the user devices 24 may present users of seller accounts 44 with a voucher creation interface 96 through the platform website 13W or platform application 13. The voucher creation interface 96 may display a plurality of sale parameter input options 98 via the display screen 24S. Once the user selects the sale parameter input options 98, the sale parameters 53 may be transmitted to the control server 12 and a new voucher record 26V for the digital voucher 50 is created and stored within the platform database 26. In one embodiment, the market transaction module 18 may be adapted to receive the voucher creation requests and write the corresponding new voucher records 26V to the platform database 26.

In one embodiment, digital vouchers 50 may be created in bundles comprising multiple digital vouchers 50 having the same virtual price 58, claim parameters 66, and redemption action data 54. Bundles of digital vouchers 50 may be sold collectively at a price equal to the sum of the virtual prices 58. Once purchased, the owner 48 of the digital vouchers 50 may unbundle the digital vouchers 50 and redeem or sell the digital vouchers 50 separately.

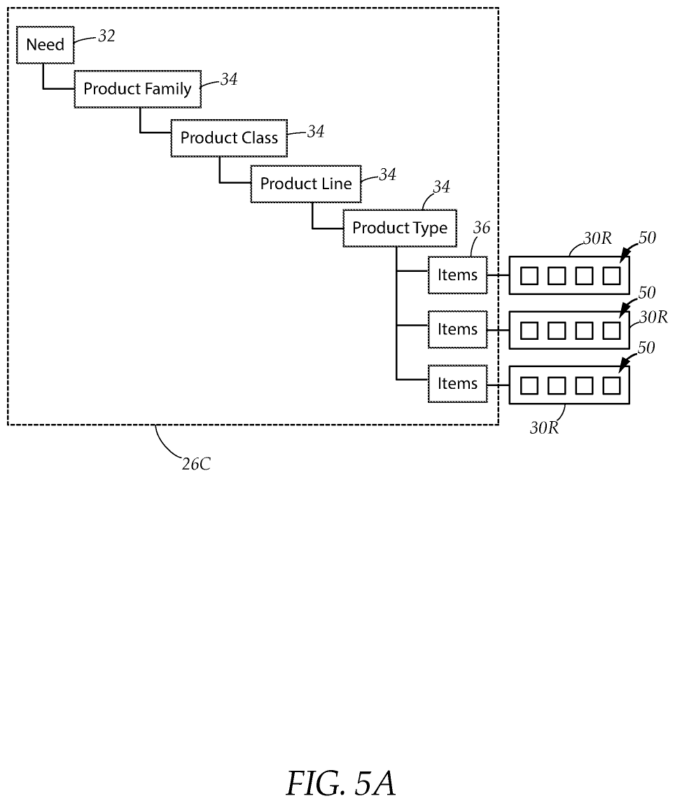

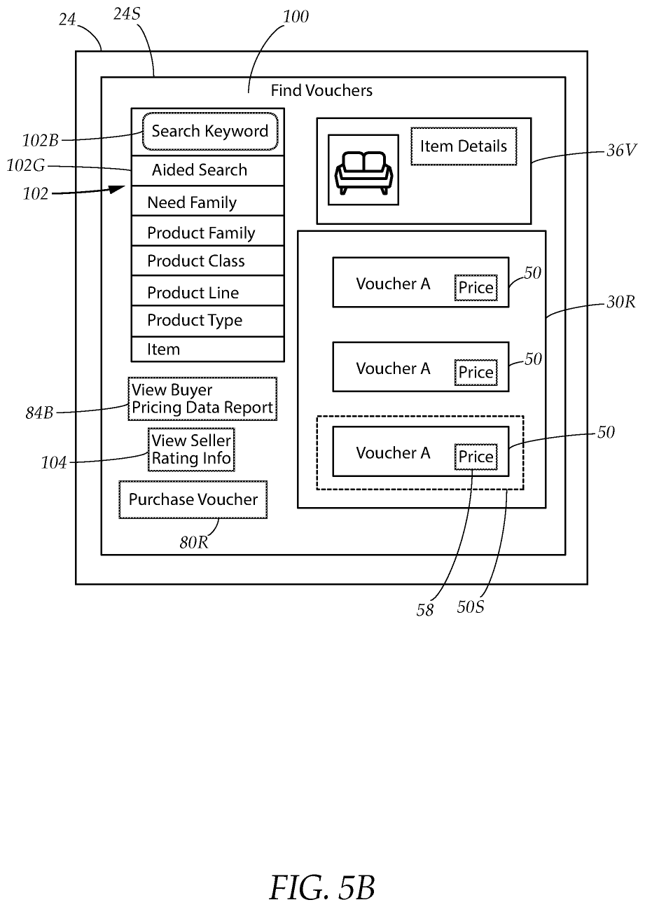

Turning to FIG. 5A and FIG. 2B while continuing to refer to FIG. 2A, the search module 14 is adapted to categorize the digital vouchers 50 to allow the buyer accounts 46 to search the voucher records 26V within the platform database 26 in order to select digital vouchers 50 to purchase. The voucher data elements 52 may therefore further contain classification parameters 32C which describe the redemption action at varying levels of specificity to facilitate search and categorization of the digital voucher 50. Products and services which are redeemable through the voucher marketplace system 10, as well as merchants, are categorized within the platform database using classification data 26C.

In one embodiment, the classification data 26C contains a hierarchical arrangement of categories 32, sub-categories 34, and item descriptions 36, in order of increasing specificity. Each category 32 may be followed by multiple levels of sub-categories 34, while each item descriptor 36 may describe a specific product or service which is associated with one of the sub-categories 34. The classification data 26C may also be used to classify specific merchants based on types of products or services offered by the merchant. To allow the classification data 26C to adequately classify digital credit offerings, the categories, sub-categories, and item descriptors 36 may be arranged to allow digital credit to be classified by merchant and credit balance. For example, different item descriptors 36 may be used to describe specific combinations of merchant and credit balance.

In one example, the categories 32 may correspond to one of a plurality of need categories corresponding to broad consumer or commercial needs. Each category 32 may have a plurality of sub-categories 34 each corresponding to a product family. Each product family in turn has a plurality of sub-categories 34 each corresponding to a product class, while each product line has a plurality of sub-categories 34 each corresponding to a product type. Each item descriptor 36 may correspond to a specific model of product, or a specific service, which is grouped under one of the product types. Note that this example is merely illustrative, and the categories 32 and sub-categories 34 can represent any concept which facilitates categorization of products, services, and merchants.

The classification parameters 32C are used to link each digital voucher 50 to the classification data 26C, thus allowing the voucher records 26V to be searchable. The classification parameters 32C of each digital voucher 50 may identify one of the item descriptors 36, and may also identify each sub-category 34 and category 32 associated therewith. A digital voucher 50 may be retrieved from the platform database 26 if a search is made using a search parameter 30P containing a combination of category 32, sub-category 34, or item descriptor 36, which matches the classification parameters 32C of the digital voucher 50.

Turning to FIG. 5B while also referring to FIG. 1A, FIGS. 1D-E, FIG. 2A, FIG. 2B, and FIG. 5A, a user 23 of a buyer account 46 may search for digital vouchers 50 using any of the categories 32, sub-categories 34, or item descriptors 36. In one embodiment, the platform application 13 or platform website 13W may be used to present the user 23 of a buyer account 46 with a buyer interface 100 via one of the user devices 24. The buyer interface 100 may allow the user 23 to input search options 102 which will be used to generate a search request containing specific search parameters 30P. The search options 102 may include a keyword search 102B, and an aided search interface 102G. In one embodiment, the aided search interface 102G allows the user 23 to search by category 32, sub-category 34, or item descriptor 36, virtual price 58, as well as geographic parameters or other common search options as will be apparent to a person of ordinary skill in the art in the field of the invention.

In one embodiment, the buyer interface 100 may allow the user 23 to view search results 30R corresponding to digital vouchers 50 which match the inputted search parameters 30P, view item details 36V of items associated with the search results 30R, as well as the virtual price 58 of each digital voucher 50. The buyer interface 100 may also allow the user 23 to view 104 a seller rating report related to the issuer 40 of a digital voucher 50, and view a buyer pricing data report 84B. The buyer interface 100 may also allow the user 23 to select 50S one of the digital vouchers 50 and submit a voucher purchase request 80R to the market transaction module 18. In one embodiment, the voucher marketplace system 10 allows the owner 48 of each digital voucher 50 to submit seller feedback, which is stored within the seller account profile 26PS as rating data 162R. The rating data 162R is used to generate the seller rating report, and may be based on various factors such as the quality of the products or services offered by the merchant associated with the seller account.

Referring to FIG. 2F while also referring to FIG. 2A and FIG. 2E, the market transaction module 18 is adapted to carry out a primary voucher sale transaction 80T, whereby a digital voucher 50 held by the issuer 40 is purchased by a buyer account 46. In one example, a voucher purchase request 80R may be submitted to the marketplace transaction module 18 via a buyer account 46. In one embodiment, a voucher purchase request 80R may identify the selected digital voucher 50 using the voucher identifier 50D. The voucher marketplace system 10 provides various marketplace functions which allow a digital voucher 50 to be selected manually for purchase, or automatically. The marketplace transaction module 18 carries out the voucher sale transaction 80T by initiating a payment transfer via the payment module 20, whereby the purchasing buyer account 46 pays the virtual price 58 to the seller account 44. Once the payment transfer is completed, the market transaction module 18 populates the owner identifier 48D of the voucher record 26V with the user identifier 161 of the buyer account 46, thus granting the new owner 48 control of the digital voucher 50. In one embodiment, each sale transaction may be recorded within the transaction records 26T stored within the platform database 26, identifying the parties to the sale transaction and the virtual price 58, as well as timing information such as the date and time of the sale transaction.

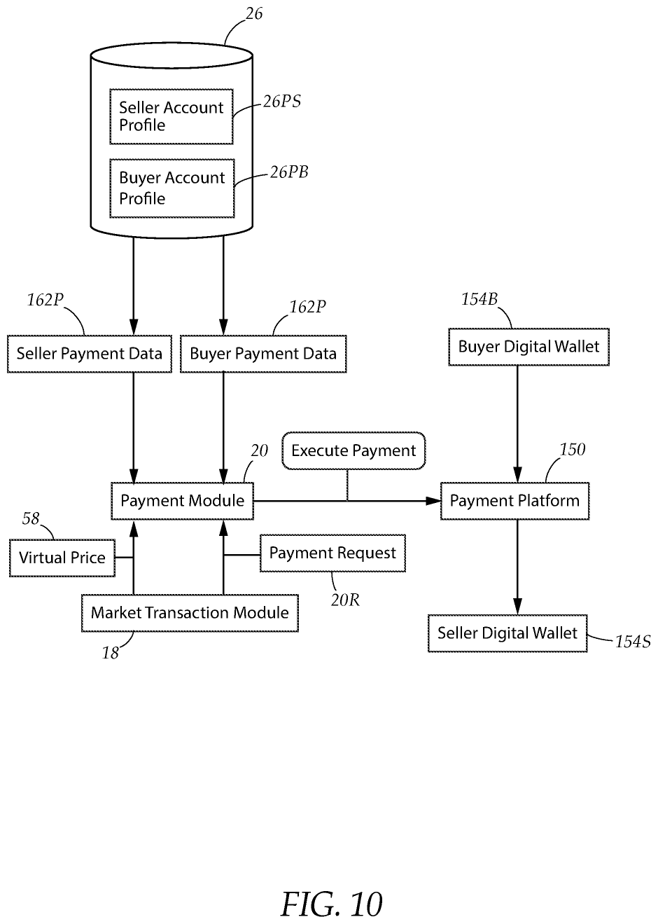

Turning to FIG. 10 while also referring to FIG. 1A, FIG. 1E, and FIGS. 2A-D, the payment module 20 is adapted to carry out payment requests 20R which may be initiated by the market transaction module 18 or the voucher execution module 20. Each payment request 20R specifies a payment sender, a payment recipient, and a payment amount. In one embodiment, the payment data 162P of each user profile 26P references a digital wallet, with the buyer account 46 being associated with a buyer digital wallet 154B, and the seller account 44 being associated with a seller digital wallet 154S. A payment request for a primary voucher sale transaction 80T will identify the buyer account 46 as the payment sender, and the seller account 44 as the payment recipient. The payment amount may correspond to the virtual price 58 of the digital voucher 50 being purchased. The payment module 20 receives the payment request 20R, and then transmits the payment amount along with the payment data 162P of the buyer account 46 and the seller account 44 to a payment platform 150. The payment platform 150 will then transfer currency equal to the payment amount from the buyer digital wallet 154B to the seller digital wallet 154S. The payment platform 150 may be any electronic payment system or service suitable for transferring payments.

Turning to FIG. 3 while also referring to FIG. 1A, FIG. 1E, and FIGS. 2A-D, a digital voucher 50 may be redeemed by its owner 48. In one embodiment, a digital voucher 50 may be redeemed manually by allowing a user 23 to submit a voucher redemption request 22R via one of the user devices 24. The voucher redemption request 22R identifies the digital voucher 50 to be redeemed, and is processed by the voucher execution module 22. In one embodiment, the voucher execution module 22 retrieves the voucher record 26V of the digital voucher 50 from the platform database 173, and reads the redemption action data 54. The redemption action is a commercial transaction, and the data 54 is formatted to contain the necessary information to allow the commercial transaction to be carried out. The commercial transaction corresponds to either delivery of a product or performance of a service specifically identified within the redemption action data 54, or debiting of a digital credit balance to fund a purchase using digital credit associated with the digital voucher 50. The voucher execution module 22 is therefore adapted to initiate a redemption delivery request 57D to initiate delivery or performance of a product or service, or initiate a credit-based purchase 57C.

In one embodiment, the redemption action data 54 contains an item identifier 36D which identifies a specific product or service, and delivery data 28D. The delivery data 28D may indicate that the product or service is to be delivered to, or performed at a redemption location. For example, the redemption location may be a physical location such as a delivery address stored within the user delivery data 162D of the buyer account profile 26PB of the owner 48, or a store location at which the product may be picked up or where the service may be performed. The redemption action may be carried out through an e-commerce platform 152, which can be internal to the digital voucher marketplace system 10, or be a third party platform such as an internet retail service or a point of sale system within a physical store, and the voucher execution module 22 is adapted to be interoperable with the e-commerce platform 152. In one embodiment, the voucher marketplace system 10 may further have a delivery API 28 to facilitate interoperability between the voucher execution module 22, the e-commerce platform 152, and systems used by parcel delivery, courier, or postal services.

The redemption delivery request 57D may cause an order to be placed through the e-commerce platform 152 for the product described by the item identifier 36D. In one embodiment, the redemption action data 54 may contain computer code or other instructions configured to submit the redemption delivery request 57D as an order to the e-commerce platform 152. The voucher execution module 22 may retrieve the user delivery data 162D from the buyer account profile 26PB of the owner 48 and provide the delivery address to the e-commerce platform 152, while the delivery API allows a shipping label to be generated automatically, thus allowing the product to be shipped to the redemption location.

In one embodiment, the redemption action data 54 of a digital voucher 50 may include a compensation action, which is carried out by the voucher execution module 22 should a valid redemption delivery request 57D fail to be successfully executed. The compensation action may correspond to a refund of the payment amount or another compensation amount defined by the issuer 40.

In lieu of an item identifier 36D and delivery data 28D, a digital voucher 50 may have a credit value 56 and a credit balance 56B. The redemption action 54 therefore allows a credit-based purchase transaction 57C to be carried out with the e-commerce platform 152 in order to purchase products or services with credit instead of currency. The credit value 56 identifies a currency type corresponding to a currency, such as dollars, while the credit balance 56B indicates the amount of credit which is available for use. A user 23 may place an order via the e-commerce platform 152 for a product or service, and then select a digital voucher 50 as a payment method in lieu of currency, causing the voucher execution module 22 to carry out a credit-based purchase transaction 57C. The voucher execution module 22 may reduce 57B the credit balance 56B of the digital voucher 50 by an amount equal to a credit-based purchase amount, causing the appropriate voucher record 26V to be updated accordingly within the platform database 26.

In one embodiment, once a digital voucher 50 containing an item identifier 36D has been redeemed and the redemption delivery request 57D has been completed, the digital voucher 50 is deactivated 62D by the voucher execution module 22, and the activation status 62 is updated to the deactivated status to prevent the digital voucher 50 from being redeemed again. Alternatively, where the digital voucher contains a credit balance 56B, the voucher execution module 22 will deactivate 62D the digital voucher 50 and update the activation status 62 to the deactivated status once the credit balance 56B is depleted.

Referring to FIG. 2A-D, FIG. 3, and FIG. 7, a digital voucher 50 which has a redeemed activation status 62 cannot be sold by the owner 48. A digital voucher 50 containing an item delivery identifier 36D which has already been redeemed cannot be sold via a secondary voucher sale transaction 80ST. However, a digital voucher 50 containing a credit balance which has not been depleted, can be sold by the owner 48 to another buyer account 46 via a secondary voucher salle transaction 80ST. However, the virtual price 58 of a digital voucher 50 having a credit balance 56B which has been reduced, will be lowered to reflect the decreased worth of the digital voucher 50.

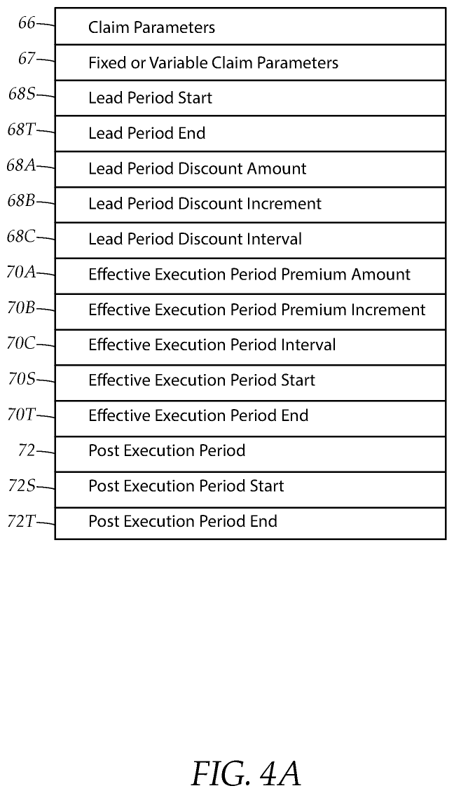

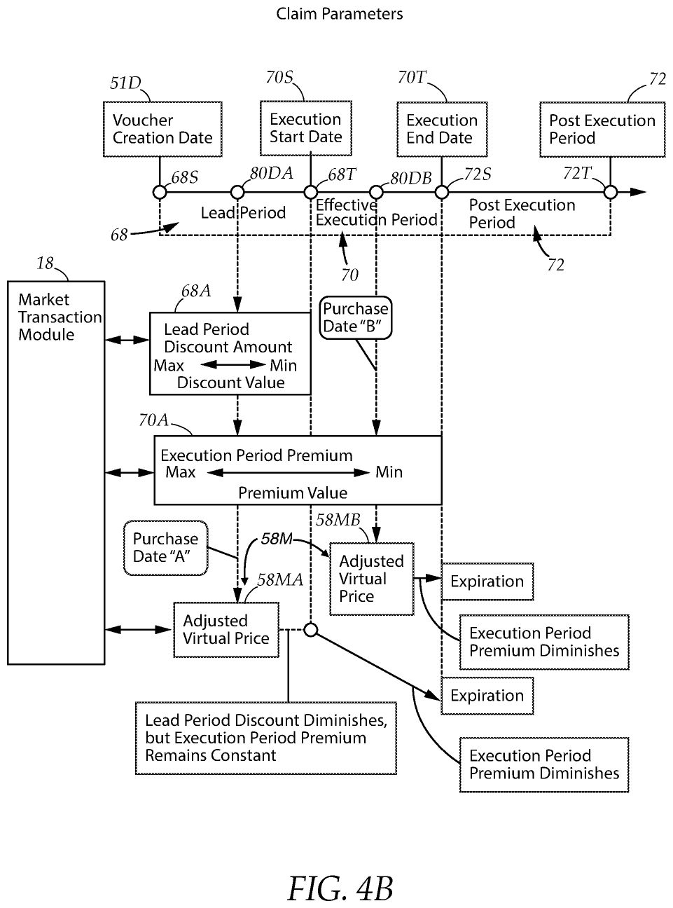

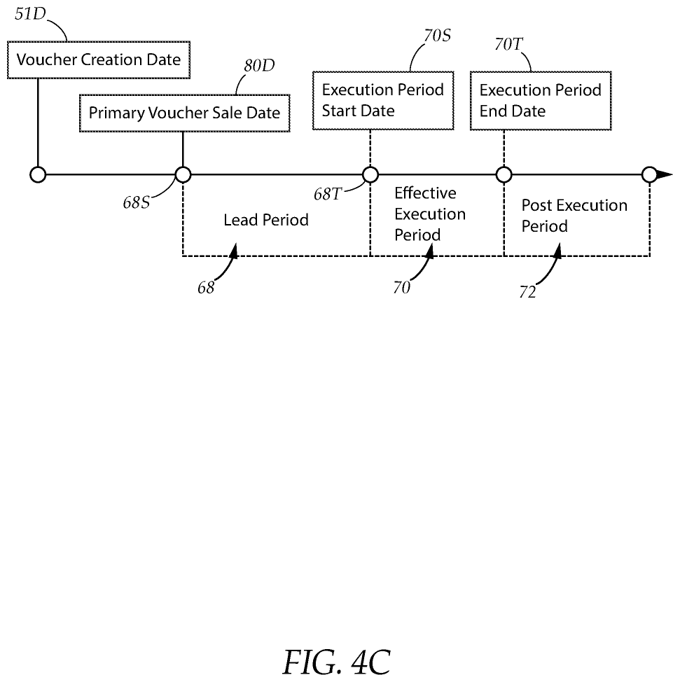

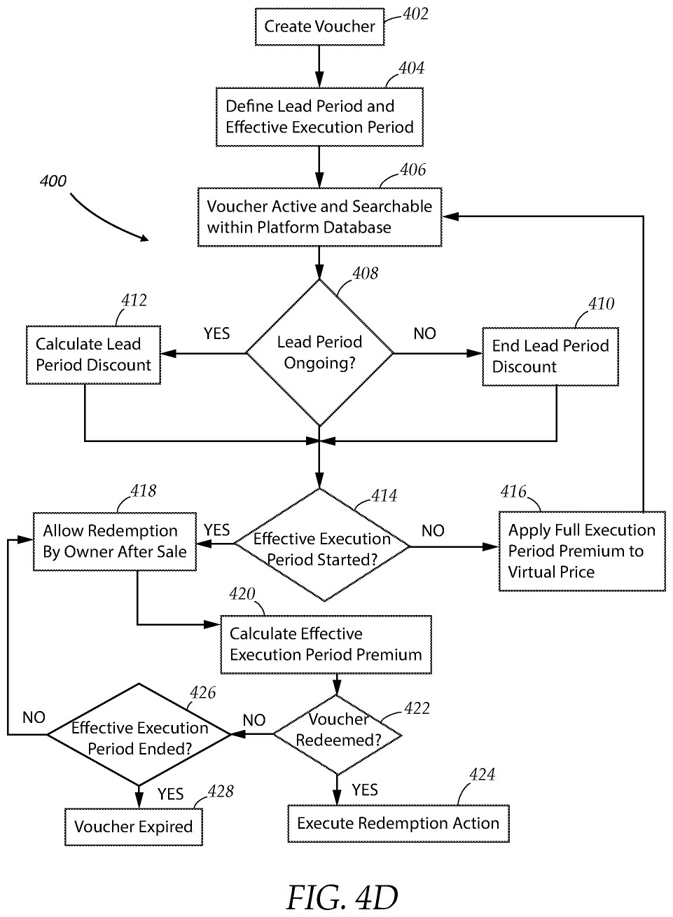

Turning to FIG. 4A-B while also referring to FIG. 1A, FIGS. 2A-B, and FIG. 7, each digital voucher 50 may have claim parameters 66 which create time-based price modifications which affect the virtual price 58 of the digital voucher 50, and time-based redemption conditions which permit or prevent the digital voucher 50 from being redeemed. The claim parameters 66 are defined by the issuer 40, and cannot be altered by the owner 48 of a digital voucher 50.

In a preferred embodiment, the claim parameters 66 define a lead period 68, an effective execution period 70, and a post-execution period 72. The effective execution period 70 is a time-interval during which the voucher execution module 22 allows the digital voucher 50 to be redeemed. The effective execution period 70 is defined by claim parameters 66 corresponding to an effective execution period start 70S and an effective execution period end 70T.

The post-execution period 72 is a period of time which follows the effective execution period 70. Once the effective execution period 70 ends and the post-execution period 72 begins, the digital voucher 50 is considered to be expired and may be deactivated. However, in certain embodiments, a digital voucher 50 may have an expiration action 60 which occurs during the post-execution period 72. The post-execution period 72 may be defined by a post-execution period start 72S which corresponds to the effective execution period end 70T, and a post-execution period end 72T.

The lead period 68 is a time-interval during which precedes the effective execution period 70, during which the digital voucher 50 may be purchased by a buyer account 46, but is not permitted to be redeemed by the owner 48. The lead period 68 is defined by claim parameters 66 corresponding to a lead period start 68S, and a lead period end 68T. A primary or secondary voucher sale transaction 80T, 80ST which occurs during the lead period 68, causes a price modification where the virtual price 58 is reduced by a lead period discount amount 68A. The lead period discount amount 68A may be a fixed amount. Alternatively, the lead period discount amount 68A may be a variable amount which is inversely proportional to the lead period 68. The lead period discount amount 68A provides an incentive to encourage advance sales, whereby the digital voucher 50 may be purchased at a discounted price in advance of redemption.

In one embodiment, the claim parameters 66 may further comprise a lead period discount increment 68B and a lead period discount interval 68C, whereby the lead period discount amount 68A is steadily reduced by the lead period discount increment 68B for each lead period discount interval 68C which transpires. For example, an example lead period 68 may cover ten days, with an initial lead period discount amount 68A of ten dollars, a lead period discount increment 68B of one dollar, and a lead period discount interval 68C of one day. Four days after the lead period start 68S, the lead period discount amount 68A will have been reduced from ten dollars, to six dollars.

The effective execution period 70 is associated with an effective execution period premium amount 70A, whereby a primary or secondary voucher sale transaction 80T, 80ST which occurs prior to the effective execution period end 70T causes a price modification where the virtual price 58 is increased by the effective execution period premium amount 70A. As with the lead period discount amount 68A, the effective execution period premium amount 70A may be a fixed amount, or a variable amount which is proportional to the length of the effective execution period 70. In one embodiment, the claim parameters 66 further comprise an effective execution period increment 70B, and an effective execution period interval 70C. The effective execution period premium amount 70A is steadily reduced by the effective execution period increment 70B for each effective execution period interval 70C which transpires. The effective execution period premium 70A therefore allows a digital voucher 50 with a long effective execution period 70 to be sold at a premium price compared to other digital vouchers 50 which expire more quickly.

For example, an effective execution period 70 may cover 20 days, with an initial effective execution period premium of twenty dollars, an effective execution period increment of two dollars, and an effective execution period interval of one day. Ten days after the effective execution period start 70S, the effective execution period premium amount 70A will have been reduced from twenty dollars, to zero dollars.

The virtual price 58 is regularly updated to produce a modified virtual price 58 which incorporates the lead period discount amount 68A, and the effective execution period premium amount 70A where applicable, and the initial virtual price 58 and the modified virtual price 58M may both be presented to the user 23 of a buyer account 46 viewing the details of the virtual voucher 50, such as part of the search results 30R.

In one embodiment, the claim parameters 66 may be designated as either fixed or variable, via a fixed or variable parameter 67. Fixed claim parameters 66 cause the lead period 68, effective execution period 70, and post-execution period 72 to be fixed in relation to a voucher creation date 51D, corresponding to the date upon which the digital voucher 50 was first created and stored within the platform database 26. The lead period start 68S may therefore begin at the voucher creation date 51D. The lead period end 68T may be set to occur a specified time after the lead period start 68S. Similarly, the effective execution period start 70S may coincide with the lead period end 68T, with the effective execution period end 70T and the post-execution period start 72S occurring a specified time after the effective execution period start 70S. It is possible for a digital voucher with fixed claim parameters 66 to expire or otherwise enter the post-execution period 72 prior to undergoing a primary voucher sale transaction 80T.

Referring to FIG. 4D while also referring to FIG. 1A, FIGS. 2A-B, FIGS. 4A-B, and FIG. 7, an example voucher pricing process 400 is shown. The process 400 begins at step 402 with the creation of a digital voucher 50 and the defining of a voucher creation date 51D. At step 404, the claim parameters 66 which determine the lead period 68 and effective execution 70 are defined by the issuer 40 along with the sale parameters 53. At step 406, the digital voucher 50 is marked with the active activation status 62, and is made searchable within the platform database 26.

In a preferred embodiment, the market transaction module 18 is adapted to monitor the lead period 68 and effective execution period 70. At step 408, the market transaction module 18 determines whether the lead period 68 is ongoing. If the lead period 68 is ongoing, the process proceeds to step 412 and the lead period discount amount 68A is calculated based on the remaining duration of the lead period 68. However, if the lead period end 68T has been reached, the process proceeds from step 408 to step 410, whereupon the lead period discount amount 68A is no longer applied to the virtual price 58. Next, the process proceeds to step 414 from both steps 410 and 412, and the market transaction module 18 determines if the effective execution period start 70S has been reached. If the effective execution period start 70S has not yet been reached, the market transaction module 18 modifies the virtual price 58 by adding the full effective execution period premium amount 70A. Following step 416, the process 400 returns to step 406.

If the effective execution period start 70S has been reached at step 414, the process 400 proceeds to step 418, at which the voucher execution will permit the digital voucher 50 to be redeemed by the owner 48 thereof. Next, at step 420, the market transaction module 18 calculates the effective execution period premium amount 70A, based on the duration of the remaining effective execution period 70. The modified virtual price 58M may continue to be calculated after the digital voucher 50 has been sold, as the owner 48 may choose to allow the digital voucher 50 to be purchased through a secondary voucher sale transaction 80ST.

Once the effective execution period 70 has begun, the digital voucher 50 will either be redeemed by the owner 48, or the digital voucher 50 will expire once the effective execution period end 70T is reached. Therefore, if the digital voucher 50 is redeemed at step 422, the voucher execution module 22 executes the redemption action at step 424. If the digital voucher 50 is not redeemed at step 422, the process proceeds to step 426, and the market transaction module 18 checks if the effective execution period end 70T has been reached. If the effective execution period end 70T has been reached, the digital voucher 50 is considered to be expired and the activation status 62 is updated accordingly at step 428. If the effective execution period end 70T has not been reached, the process returns to step 418. In one embodiment, a digital voucher 50 cannot be sold via a primary or secondary voucher sale transaction 80T, 80ST once the effective execution period 70 has ended.

An exemplary primary voucher sale transaction 80T which is initiated at a Purchase Date “A” 80DA occurring within the lead period 68 would be carried out at a modified virtual price 58MA equal to the original virtual price 58, reduced by the lead period discount amount 68A, and increased by the full effective execution period premium amount 70A. The exemplary Purchase Date “A” 80DA would occur between steps 406 and 414 of the example voucher pricing process 400.

An exemplary primary or secondary voucher sale transaction 80T, 80ST which is initiated at Purchase Date “B” 80DB occurring within the effective execution period 70, would be carried out at a modified virtual price 58MB equal to the original virtual price 58, increased by the effective execution period premium amount 70A. The modified virtual price 58MB does not include the lead period discount amount 68A, as the lead period 68 has already ended. However, the effective execution period premium amount 70A may be incrementally reduced as the effective execution period end 70T approaches.

Turning to FIG. 4C while also referring to FIG. 1A, FIGS. 2A-B, FIG. 4A, and FIG. 7, where a digital voucher 50 has variable claim parameters 66, the lead period 68, effective execution period 70, and post-execution period 72 are not determined at the time the digital voucher 50 is created. Instead, the lead period start 68S begins at an original sale date 80D corresponding to primary voucher sale transaction 80T. Therefore, unlike a digital voucher 50 with fixed claim parameters 66 which has been listed for sale but which goes unsold, a digital voucher 50 with variable claim parameters 66 will not expire prior to being sold through a primary voucher sale transaction 80T. If the digital voucher 50 is sold by the owner 48 via a secondary voucher sale transaction 80ST, the lead period 68, effective execution period 70, and post-execution period 72 continue to be determined relative to the original sale date 80D.

Note that a digital voucher 50 with fixed or variable claim parameters 66 can be created without a lead period 68, allowing for immediate redemption by the owner 48, as the effective execution period 70 would begin immediately after the primary voucher sale transaction 80T.

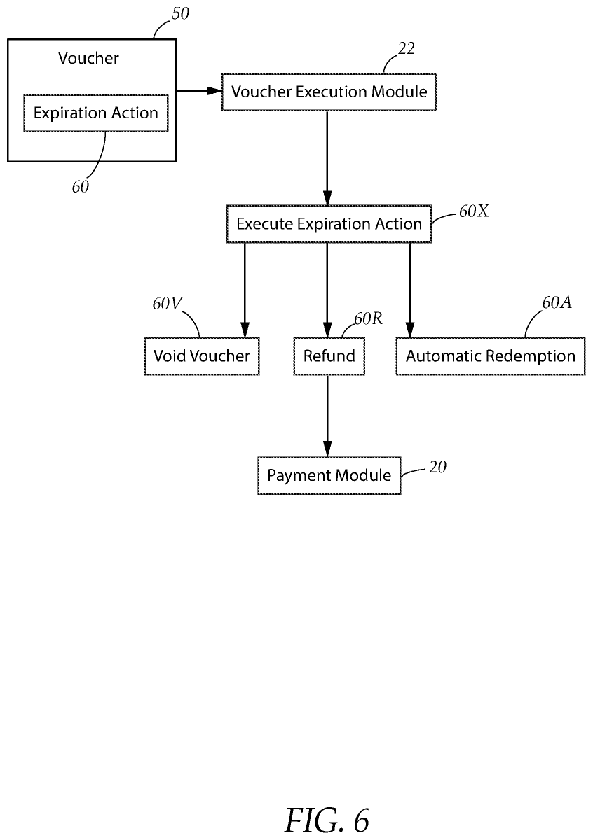

Referring to FIG. 4A-C while also referring to FIG. 1A, FIGS. 2A-B, FIG. 2F, FIG. 3, and FIG. 6, each digital voucher 50 is associated with an expiration action 60 which is carried out by the control server 12 once the effective execution period 70 has ended or when the post-execution period 72 has begun. The expiration action 60 may be stored within the voucher record 26V of the digital voucher 50, and is defined by the issuer 40 at the time the digital voucher 50 is created.

In one embodiment, the voucher execution module 22 is adapted to execute 60X the expiration action 60. The expiration action 60 may correspond to a void voucher action 60V, a refund action 60R, or an automatic redemption action 60A. When a void voucher action 60V is carried out, the digital voucher 50 is deactivated and can no longer be redeemed or sold, and the activation status 62 is updated accordingly. When a refund action 60R is carried out, the voucher execution module 22 may cause the payment module 20 to refund the payment amount of the original voucher sale transaction to the owner 48, such as by transferring the payment amount from the issuer 40 to the owner 48. When an automatic redemption action 60A is carried out, the voucher execution module 22 may automatically carry out the redemption action as specified by the redemption action data 54. For example, where the redemption action data 54 describes an item identifier 36D, the voucher execution module 22 may automatically initiate a redemption delivery request 57D on behalf of the owner 48. Once either a refund action 60R or an automatic redemption action 60A is carried out, the digital voucher 50 is deactivated.

In certain embodiments, the issuer 40 may define more than one expiration action 60, allowing the owner 48 to select one of the expiration actions 60 to be carried out prior to the post-execution period end 72T. For example, the owner 48 may be allowed to select either a refund action 60R or an automatic redemption action 60A. If the owner 48 makes no selection, the voucher execution module 22 may automatically carry out the void voucher action 60V once the post-execution period end 72T is reached.

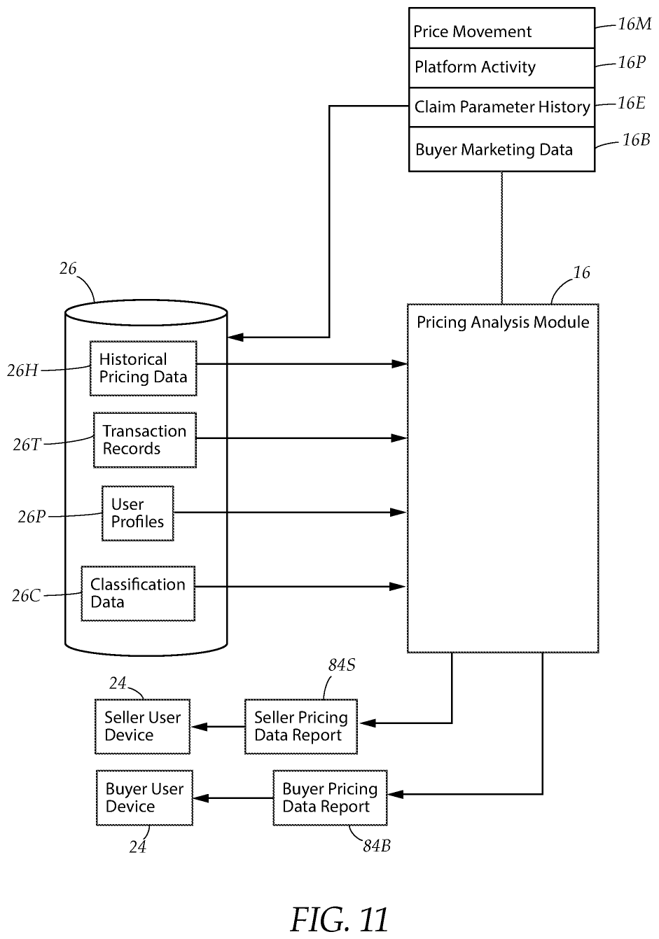

Referring to FIG. 2A and FIG. 11, while also referring to FIGS. 1A-B, FIG. 2B, FIG. 5A, and FIG. 7, the platform database 26 maintains historical pricing data 26H, which contains a range of data describing the digital vouchers 50 created through the voucher marketplace system 10, and details related to completed primary and secondary voucher sale transactions 80T, 80ST stored within the transaction records 26T. The pricing analysis module 16 is adapted to analyze the historical pricing data 26H and generate seller pricing data reports 84S and buyer pricing data reports 84B, which are viewable by users of seller accounts 44 and buyer accounts 46 respectively.

In one embodiment, the historical pricing data 26H includes price movement data 16M, platform activity data 16P, claim parameter history data 16E, and buyer marketing data 16B. The historical pricing data 26H may be broken down by classification data 26C, redemption action, or any other appropriate category or classification which can be determined through analysis of the platform data elements 26D.

The price movement data 16M tracks pricing trends, and records current and historical virtual prices 58 based on completed sales of digital vouchers 50. The price movement data 16M allows the pricing analysis module 16 to track a market price 82 for each item descriptor 36. The market price 82 for an item descriptor 36 is based on the payment amount of the most recent completed sale of a digital voucher 50 associated with the item descriptor 36. The market price 82 therefore serves as an indicator of the price that buyers are willing to pay, and which sellers are willing to accept for a product or service associated with the item descriptor 36. In certain embodiments, a separate market price 82 may be tracked for primary voucher sale transactions 80T, and secondary voucher sale transactions 80ST.

Every completed sale of a digital voucher 50 will cause the market price 82 to be updated, and the seller and buyer pricing data reports 84S, 84B may display the market price 82 in real-time. The price movement data 16M may also be used to construct a historical price gap record, which quantifies the difference between the virtual price 58 and the market price 82 for each completed voucher sale transaction. The historical price gap record may also be used to determine an average price gap which shows the difference between the virtual price and the market price across a specific time period. The pricing analysis module 16 may also allow the data within the historical price gap record to be organized by item descriptor 36, thus allowing users 23 to view price gap trends for specific items.

The platform activity data 16P measures historical sales volumes of digital vouchers 50. The platform activity data 16P also measures supply data by tracking the quantity of the digital vouchers 50 which are currently available for purchase on the voucher marketplace system 10. The supply data may also include the quantity of unredeemed digital vouchers 50 which have been purchased by buyers 46 and which are currently eligible for redemption.

Referring to FIG. 4A-B and FIG. 11 while also referring to FIGS. 1A-B and FIG. 2B, the claim parameter history data 16E records trends related to lead periods 68, effective execution periods 70, and post-execution periods 72. The claim parameter history data 16E records lead period discount amounts 68A, effective execution period premium amounts 70A, as well as applicable lead period discount and effective execution period premium increment and interval data. The claim parameter history data 16E further records trends regarding the use of fixed or variable claim parameters 66, as well as trends regarding expiration actions 60.

Referring to FIG. 1E and FIG. 11 while also referring to FIGS. 1A-B and FIG. 2B, the buyer marketing data 16B utilizes buyer account profile 26PB data associated with individual buyer accounts 46, such as user activity data 162H, to gain insights for buyer oriented marketing. The user activity data 162H may record buyer search and browsing activity and buyer purchasing activity. The buyer marketing data 16B may also analyze how responsiveness of the user of each buyer account 46 to discounts and promotions offered in the past.

Referring to FIG. 2E and FIG. 11 while also referring to FIGS. 1A-B and FIGS. 2A-B, a seller pricing data report 84S is configured to advise the user 23 of a seller account 44 regarding how to configure the sale parameters 53 and claim parameters 66 to maximize profit and sales volume, while preventing losses. The seller pricing data report 84S may be generated based on historical pricing data 26H applicable to the specific classification parameters 32C selected by the user 23 during the creation of a digital voucher 50. In one embodiment, the voucher creation interface 96 may present historical insights and predictions drawn from the historical pricing data 26H to aid the user 23. For example, the seller pricing data report 84S may compare the virtual price 58 and the market price 82, while also presenting the user 23 with additional pricing insights drawn from the price movement data 16M. The seller pricing data report 84S may also compare the claim parameters 66 entered by the user 23 against the claim parameter history data 16E. The seller pricing data report 84S may also include recommended adjustments to the virtual price 58 or the claim parameters 66 based on supply data drawn from the platform activity data 16P, as well as buyer marketing data 16B. The user 23 of the seller account 44 is therefore able to adjust the sale parameters 53 and claim parameters 66 prior to submitting the sale parameters 53 and the claim parameters 66 to the market transaction module 18.

Referring to FIG. 5B and FIG. 11 while also referring to FIGS. 1A-B, FIG. 1E, and FIG. 2A, the buyer pricing data report 84B informs the user 23 of a buyer account 46 of historical and current pricing trends obtained through analysis of the historical pricing data 26H. For example, the buyer pricing data report 84B may compare the virtual price 58 of one of the digital vouchers 50 against the corresponding current market price 82, and/or the historical price gap record. Thus, the user 23 of the buyer account 46 is able to determine whether the virtual price 58 is overpriced or underpriced, allowing the user 23 to make informed purchase decisions.

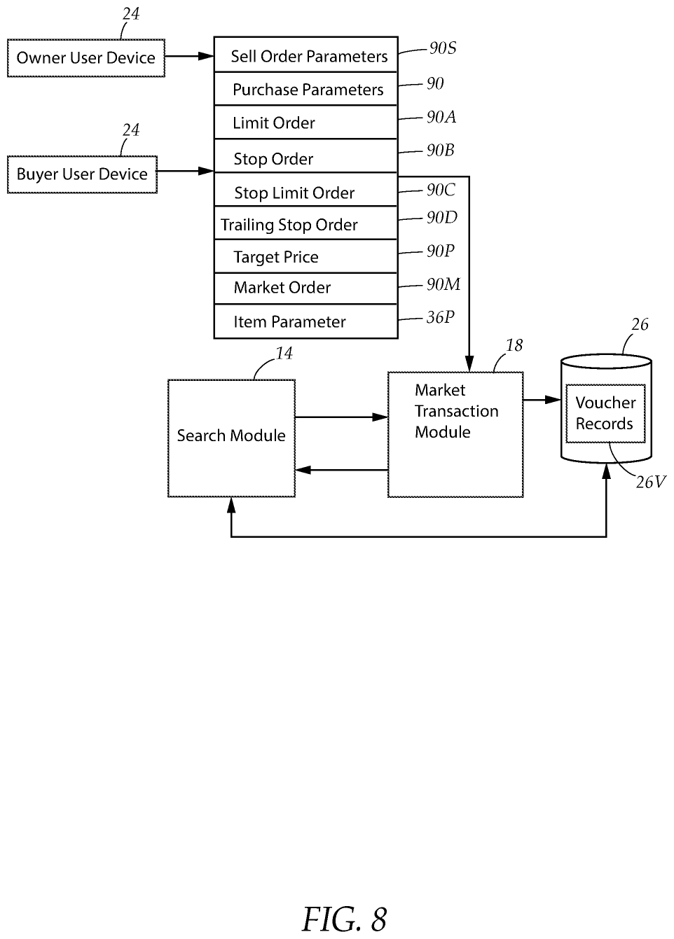

Referring to FIG. 5A, FIG. 7, and FIG. 8, while also referring to FIG. 2A, FIG. 2B, and FIG. 4B, the market transaction module 18 may also allow digital vouchers 50 to be purchased and sold using secondary voucher sale transactions 80ST according to automatic rules defined via user-selected purchase parameters 90 or sell order parameters 90S. In one embodiment, the purchase parameters 90 and sell order parameters 90S comprise at least one target price parameter 90P, an item parameter 36P, and an order type. The order type may either be a market order 90M, a limit order 90A, a stop order 90B, a stop limit order 90C, or a trailing stop order 90D. Each order type corresponds to a stock market order type of the same name., as will be apparent to a person of ordinary skill in the art in the field of the invention. The item parameter 36P corresponds to an item descriptor 36, and instructs the market transaction action module 18 to apply the automatic rule towards purchasing or selling digital vouchers 50 containing the item descriptor 36. The target price parameter 90P corresponds to a price or other condition which causes the automatic rule to activate. Several examples of purchases and sales conducted using automatic rules based on the order type are described herein. However, please note that these examples are illustrative and not intended to be limiting, as there are multiple ways to apply stock market order types to voucher sale transactions using the marketplace functions described in the present disclosure.

Automatic orders can be used by the owner 48 of a digital voucher 50 to sell the digital voucher 50 using one of the order types, or by a buyer account 46 to purchase digital vouchers 50 associated with the item descriptor 36 identified by the item parameter 36P. In one embodiment, when a market order 90M is selected by the user 23 of a buyer account 46, the market transaction module 18 will automatically submit a voucher purchase request 80R for digital vouchers 50 at the lowest available virtual price 58. Conversely, when the owner 48 of a digital voucher 50 selects the market order parameter 90M when selling the digital voucher 50, the market transaction module 18 may change the virtual price 58 of the digital voucher 50 to match the current market price 82.

In one embodiment, the limit order 90A order type allows a digital voucher 50 to be purchased or sold at a price no greater that the target price parameter 90P. Conversely, the limit order type 90A allows a digital voucher 50 to be sold at a price which is equal to or higher than the target price parameter 90P. When a limit order 90A is selected by the user 23 of a buyer account 46 and a target price parameter 90P corresponding to a limit price is defined, the search module 14 will search for digital vouchers 50 having a virtual price 58 which is equal to or lower than the target price parameter 90P, and the market transaction module 18 will automatically initiate a voucher purchase request 80R to purchase the digital voucher 50 with the lowest virtual price 58 from amongst the digital vouchers 50 retrieved by the search module 14. When the owner 48 of a digital voucher 50 selects the limit order 90A parameter and sets a target price parameter 90P corresponding to a limit price to execute a sale, the market transaction module 18 may immediately make the digital voucher 50 available for purchase, while updating the virtual price 58 to match the target price parameter 90P.

In one embodiment, when a stop order 90B is selected by the user 23 of a buyer account 46 and a target price parameter 90P corresponding to a stop price is defined, the market transaction module 18 will automatically issue a voucher purchase request 80R to purchase a digital voucher 50 at the lowest available virtual price 58 once the market price 82 is equal to or less than the target price parameter 90P. Conversely, when the owner 48 of a digital voucher 50 selects the stop order 90B parameter and sets a target price parameter 90P to execute a sale, the market transaction module 18 will make the digital voucher 50 available for purchase once the market value 82 is equal to or greater than the target price parameter 90P, while updating the virtual price 58 to match the current market price 82.

In one embodiment, when a stop-limit order 90C is selected by the user 23 of a buyer account 46, two target price parameters 90P are defined with one corresponding to a stop price, and one corresponding to a limit price. Once the market price 82 is equal to or less than the stop price, the market transaction module 18 will automatically issue a voucher purchase request 80R to purchase a digital voucher 50 at the lowest available virtual price 58. However, if the lowest available virtual price 58 exceeds the limit price, the market transaction module 18 prevents the voucher purchase request 80R from being carried out. Conversely, when the owner 48 of a digital voucher 50 initiates a sale of the digital voucher 50 by selecting the stop-limit order 90C and defining target price parameters 90P corresponding to a stop price and a limit price, the market transaction module 18 may make the digital voucher 50 available for purchase once the market price 82 falls below, or rises above the stop price. The market transaction module 18 may update the virtual price 58 of the digital voucher 50 to match the current market price 82. However, the market transaction module 18 will cancel any potential sale and make the digital voucher 50 unavailable for purchase if the market price 82 falls below the limit price.

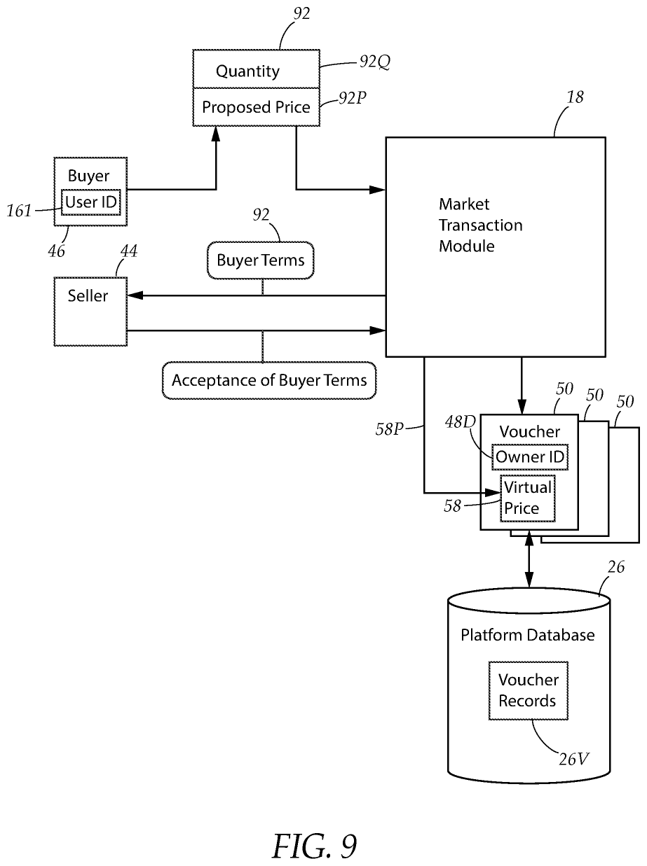

Turning to FIG. 9 while also referring to FIG. 1A and FIG. 2A, the market transaction module 18 may allow a buyer account 46 and a seller account 44 to conduct a primary voucher sale transaction 80T for one or more digital vouchers 50 at a negotiated virtual price 58P. The market transaction module 18 may allow the buyer account 46 to transmit buyer terms 92 comprising a quantity 92Q and a proposed price 92P to a seller account 44. The seller account 44 may either approve or reject the buyer terms 92, or propose a counteroffer. Once both the buyer account 46 and the seller account 44 agree on the buyer terms 92 and a negotiated price 58P is reached, the market transaction module 18 will update the virtual price 58 of the digital voucher 50 to match the negotiated price 58P, and carry out the primary voucher sale transaction 80T by updating the owner identifier 48D of the digital voucher. Where the quantity 92Q exceeds one, the primary voucher sale transaction 80T may be repeated, thus allowing multiple digital vouchers 50 to be sold at the negotiated virtual price 58P. Instead of applying the buyer terms 92 to existing digital vouchers 50, the seller account 44 may allow the market transaction module 18 to create new digital vouchers 50 with virtual prices 58 matching the negotiated virtual price 58P. Once the new digital vouchers 50 have been created, the market transaction module 18 may immediately execute primary voucher sale transactions 80T between the purchasing buyer account 46 and the seller account 44 to transfer ownership of the digital vouchers 50.

Turning to FIG. 10 while also referring to FIG. 1A, FIG. 2A, FIG. 2F, and FIG. 7, in one embodiment, the voucher marketplace system 10 may be implemented using a blockchain transaction network 222. The blockchain transaction network 222 comprises a plurality of verifier nodes 224, each corresponding to a computing device capable of executing the functions of the control server 12. The verifier nodes 224 are adapted to communicate therebetween via the data communication network 200. The functions of the control server 12 and its modules are distributed across the verifier nodes 224, and the verifier nodes 224 collectively maintain a distributed storage 220. The distributed storage 220 is used to maintain a platform blockchain 240 formed of a plurality of blocks 226, with each block 226 arranged in order of creation. Each block 226 contains distributed platform data 218, and the platform database 26 is implemented as a distributed database, with portions of the platform database 26 being stored within each blocks 226 of the platform blockchain 240. When a new voucher sale transaction 228 corresponding to a primary or secondary voucher sale transaction 80T, 80ST occurs, the transaction details are submitted 228S to the transaction network 222 for verification, and a new block 226N containing the voucher sale transaction 228 is created 226C by one of the verifier nodes 224. The new block 226N is then subjected to verification by the transaction network 222, whereby the verifier nodes 224 must collectively verify and authenticate the new block 226N and the transaction 228 stored therein using a consensus algorithm, such as proof of work, or proof of stake. Once the new block 226N is successfully verified, the verified block 226N is added to the platform blockchain 240, and the voucher sale transaction 228 is carried out. The voucher sale transaction 228 may be recorded as a transaction record 26T within the distributed platform data 218, where it can be retrieved or updated by the modules of the control server 12 in accordance with the principles of the present disclosure. Referring to FIG. 3 and FIG. 6 while continuing to refer to FIG. 10, other marketplace platform functions, such as voucher redemption requests 22R and expiration actions 60, may also be verified by the transaction network 222 in a similar manner as the voucher sale transaction 228.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. Other types of languages include XML, XBRL and HTML5. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order and/or steps may be added, deleted and/or modified. All of these variations are considered a part of the claimed disclosure.

In conclusion, herein is presented a digital voucher marketplace. The disclosure is illustrated by example in the drawing figures, and throughout the written description. It should be understood that numerous variations are possible, while adhering to the inventive concept. Such variations are contemplated as being a part of the present disclosure.

What is claimed is:

1. A method for operating a digital voucher marketplace for executing voucher sale transactions, comprising the steps of:
providing a control server having a market transaction module, a payment module, a search module, a voucher execution module, and a platform database, the platform database having a plurality of voucher records each describing a digital voucher, and a plurality of user profiles comprising one or more buyer accounts and one or more seller accounts, each seller account is associated with a merchant, the control server is adapted to communicate with a plurality of user devices each operable by a user of one of the buyer accounts or the seller accounts;
submitting a digital voucher creation request to the market transaction module by the user of one of the seller accounts via one of the user devices;
creating a new digital voucher having a virtual price, an issuer identifier identifying the issuer of the digital voucher, an owner identifier identifying an owner of the digital voucher, and redemption action data, the redemption action data describing a commercial transaction executable through an e-commerce platform, associating the issuer identifier with the seller account, and storing the digital voucher within the voucher records;
searching the platform database via the search module and selecting the digital voucher by the user of one of the buyer accounts via one of the user devices;
submitting a voucher purchase request by the buyer account to the market transaction module and initiating a primary voucher sale transaction;
executing a payment transfer via the payment module and transferring a payment amount equal to the virtual price from the buyer account to the seller account;
completing the primary voucher sale transaction by the market transaction module, and updating the owner identifier to identify the buyer account as the owner of the digital voucher;
redeeming the digital voucher by transmitting a voucher redemption request to the voucher execution module by the owner of the digital voucher; and
transmitting the redemption action data to the e-commerce platform by the voucher execution module, and carrying out the redemption action by the issuer via the e-commerce platform.

2. The method as recited in claim 1, wherein the step of completing the primary voucher sale transaction is followed by the steps of:
submitting a secondary voucher sale request to the market transaction module by the owner of the digital voucher, and making the digital voucher available for purchase by the market transaction module;
submitting a new voucher purchase request for the digital voucher to the market transaction module by a second buyer account, and initiating a secondary voucher sale transaction;
executing a second payment transfer via the payment module and transferring a second payment amount equal to the virtual price from the second buyer account to the buyer account of the owner;
completing the secondary voucher sale transaction by the market transaction module, and updating the owner identifier to identify the second buyer account as the owner of the digital voucher.

3. The method as recited in claim 2, wherein:
the control module further has a pricing analysis module;
the step of submitting a digital voucher creation request is preceded by the step of recording historical pricing data based on completed voucher sale transactions by the pricing analysis module; and
the step of searching the platform database is followed by the step of generating a buyer pricing data report by the pricing analysis module based on the historical pricing data, and displaying the buyer pricing data report via the user device of the buyer account.

4. The method as recited in claim 3, wherein:
the platform database further contains classification data, the classification data containing a plurality of item descriptors;
the step of recording historical pricing data further comprises recording historical pricing data based on completed voucher sale transactions by the pricing analysis module, whereby each completed voucher sale transaction is associated with one of the item descriptors, and tracking a market price for each item descriptor based on the most recently completed voucher sale transactions associated with the item descriptor;
the step of creating a digital voucher further comprises the digital voucher having a classification parameter corresponding to one of the item descriptors; and
the step of generating a buyer pricing data report further comprises updating and displaying the market price based on the classification parameter of the digital voucher.

5. The method as recited in claim 4, wherein:
each item descriptor in the classification data describes a product or service;
the step of transmitting the redemption action data to the e-commerce platform further comprises delivering or performing the product or service associated with the digital voucher at a redemption location, and deactivating the digital voucher.

6. The method as recited in claim 4, wherein:
the step of creating a new digital voucher further comprises defining a digital credit balance associated with the digital voucher; and
the step of transmitting the redemption action data to the e-commerce platform further comprises carrying out the redemption action by the issuer via the e-commerce platform, the redemption action corresponding to a credit-based purchase transaction funded by the digital credit balance of the digital voucher.

7. The method as recited in claim 6, wherein the step of transmitting the redemption action data further comprises depleting the digital credit balance and deactivating the digital voucher.

8. The method as recited in claim 6, wherein the step of transmitting the redemption action data further comprises partially depleting the digital credit balance;
the step of transmitting the redemption action data is followed by the steps of:
submitting an additional secondary voucher sale request to the market transaction module by the owner of the digital voucher, and making the digital voucher available for purchase by the market transaction module;
submitting an additional voucher purchase request for the digital voucher to the market transaction module by a third buyer account, and initiating an additional secondary voucher sale transaction;
executing an additional payment transfer via the payment module and transferring an additional payment amount equal to a reduced virtual price from the third buyer account to the buyer account of the owner; and
completing the additional secondary voucher sale transaction by the market transaction module, and updating the owner identifier to identify the third buyer account as the owner of the digital voucher.

9. The method as recited in claim 4, wherein:
the step of searching the platform database is followed by the step of transmitting a proposed price to the issuer of the digital voucher by the buyer account, accepting the proposed price by the issuer, and updating the virtual price of the digital voucher to reflect the proposed price.

10. A method for operating a digital voucher marketplace for executing voucher sale transactions, comprising the steps of:
providing a control server having a market transaction module, a payment module, a search module, a voucher execution module, and a platform database, the platform database having a plurality of voucher records each describing a digital voucher, and a plurality of user profiles comprising one or more buyer accounts and one or more seller accounts, each seller account is associated with a merchant, the control server is adapted to communicate with a plurality of user devices each operable by a user of one of the buyer accounts or the seller accounts;
submitting a digital voucher creation request to the market transaction module by the user of one of the seller accounts via one of the user devices, and defining a plurality of sale parameters, comprising a virtual price, and claim parameters, the claim parameters comprising a lead period start, a lead period end, an effective execution period start, and an effective execution period end, the lead period start and end define a lead period, the effective execution period start and end define an effective execution period, whereby the effective execution period start occurs after the lead period;
creating a new digital voucher using the sale parameters, the digital voucher further having an issuer identifier identifying the issuer of the digital voucher, an owner identifier identifying an owner of the digital voucher, and redemption action data, the redemption action data describing a commercial transaction executable through an e-commerce platform, associating the issuer identifier with the seller account, and storing the digital voucher within the voucher records;
counting down the lead period by the market transaction module, and then counting down the effective execution period following the lead period;
searching the platform database via the search module and selecting the digital voucher by the user of one of the buyer accounts via one of the user devices;
submitting a voucher purchase request by the buyer account to the market transaction module, and initiating a primary voucher sale transaction;
executing a payment transfer via the payment module and transferring a payment amount equal to the virtual price from the buyer account to the seller account;
completing the primary voucher sale transaction by the market transaction module, and updating the owner identifier to identify the buyer account as the owner of the digital voucher;
comparing a current date to the effective execution period, and allowing the digital voucher to be redeemed upon the current date passing the effective execution period start;
redeeming the digital voucher by transmitting a voucher redemption request to the voucher execution module by the owner of the digital voucher; and
transmitting the redemption action data to the e-commerce platform by the voucher execution module, and carrying out the redemption action by the issuer via the e-commerce platform.

11. The method as recited in claim 10, wherein:
the step of submitting a digital voucher creation request further comprises defining a lead period discount amount;
the step of submitting a voucher purchase request further comprises initiating a primary voucher sale transaction during the lead period; and
the step of executing a payment transfer further comprises transferring a payment amount equal to the virtual price reduced by the lead period discount amount, from the buyer account to the seller account.

12. The method as recited in claim 11, wherein:
the step of submitting a digital voucher creation request further comprises defining an effective execution period premium amount; and
the step executing a payment transfer further comprises transferring a payment amount equal to the virtual price reduced by the lead period discount amount, and increased by the effective execution premium amount.

13. The method as recited in claim 12, wherein the step of completing the primary voucher sale transaction is followed by the steps of:
submitting a secondary voucher sale request to the market transaction module by the owner of the digital voucher, and making the digital voucher available for purchase by the market transaction module;
submitting a new voucher purchase request for the digital voucher to the market transaction module by a second buyer account, and initiating a secondary voucher sale transaction during the lead period;
reducing the lead period discount amount by a magnitude inversely proportional to the remaining lead period;
executing a second payment transfer via the payment module and transferring a second payment amount equal to the virtual price reduced by the lead period discount, from the second buyer account to the buyer account of the owner; and
completing the secondary voucher sale transaction by the market transaction module, and updating the owner identifier to identify the second buyer account as the owner of the digital voucher.

14. The method as recited in claim 10, wherein:
the step of submitting a digital voucher creation request further comprises defining an effective execution period premium amount;
the step of submitting a voucher purchase request further comprises initiating a primary voucher sale transaction during the effective execution period;
the step of executing a payment transfer further comprises transferring a payment amount equal to the virtual price increased by the effective execution period premium amount, from the buyer account to the seller account.

15. The method as recited in claim 14, wherein the step of completing the primary voucher sale transaction is followed by the steps of:
submitting a secondary voucher sale request to the market transaction module by the owner of the digital voucher, and making the digital voucher available for purchase by the market transaction module;
submitting a new voucher purchase request to the market transaction module by a second buyer account, and initiating a secondary voucher sale transaction during the effective execution period;
reducing the effective execution period premium amount by a magnitude inversely proportional to the remaining effective execution period;
executing a second payment transfer via the payment module and transferring a second payment amount equal to the virtual price increased by the effective execution period premium, from the second buyer account to the buyer account of the owner; and
completing the secondary voucher sale transaction by the market transaction module, and updating the owner identifier to identify the second buyer account as the owner of the digital voucher.

16. The method as recited in claim 10, wherein:
the control module further has a pricing analysis module;
the step of submitting a digital voucher creation request is preceded by the step of recording historical pricing data based on completed voucher sale transactions by the pricing analysis module; and
the step of submitting a digital voucher creation request is followed by the step of generating a seller pricing data report by the analysis module based on the historical pricing data, the seller pricing data report comparing the claim parameters defined by the user of the seller account against claim parameter history data stored within the historical pricing data, and presenting the user of the seller account with recommended adjustments to the claim parameters via one of the user devices.
